(19) United States
(12) Patent Application Publication
(10) Pub. No.: US 2008/0267251 A1
(43) Pub. Date: Oct. 30, 2008

(54) STACKED INDUCTION FURNACE SYSTEM

(76) Inventors: Charles C. Gerszewski, Wauwatosa, WI (US); John A. Voumard, Brookfield, WI (US); James P. Landis, Milwaukee, WI (US); George Eischen, Random Lake, WI (US)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 11/741,970

(22) Filed: Apr. 30, 2007

(51) Int. Cl. F27D 3/14

(52) U.S. Cl. 373/142

(57) ABSTRACT

A stacked induction furnace system includes a first furnace having an induction coil to heat and melt a substantially non-conductive material contained in an upper crucible. The upper crucible contains an opening in a bottom surface thereof to drain molten material therefrom. A second furnace is positioned below the first furnace and includes a lower crucible to receive the molten material drained from the opening and is arranged to maintain the molten state of the material in the lower crucible. One or more power sources are provided to power the first furnace and the second furnace.

### BACKGROUND OF THE INVENTION

The present invention relates generally to an induction melting furnace and, more specifically, to a stacked induction melting furnace constructed to promote a continuous melting process of a solid, substantially non-conductive material to recover precious metals therefrom.

Induction furnaces are a well-known system used in casting operations and reclamation processes for heating and melting metal and other materials containing amounts of metal therein, such as low grade ore or rock containing small quantities of metal therein. With previous designs, it has been difficult to continuously melt these materials without interruption for pouring and refilling. An intermittent melting method has been used in which material is first conveyed into the furnace, then raised in temperature until it is molten wherein the molten metal therein can then be discharged from the furnace. When the material has been melted and superheated to the desired pouring temperature, power to the induction furnace is typically either turned off or reduced in order to maintain the temperature of the material during a pouring operation. This pouring operation commonly involves at least tilting or tipping a crucible in which the molten material is held, but also can include moving the crucible to another location before the pour. When the desired amount of molten material has been removed from the furnace, the next batch of material is conveyed in and full power is once again applied to the furnace to begin the next melt cycle. Thus, the conventional induction melting furnace is of the type of which discharges the molten material intermittently and does not allow for a process in which material is continuously added, melted, and discharged.

As stated above, conventional induction furnaces do not allow for a continuous melting process. Such an intermittent melting operation is not only time consuming, but such intermittent melting can also lead to other problems. For example, “bridging” can occur during a melting process, in which the molten material solidifies on the top surface of the melt. When bridging occurs, gases can accumulate in the crucible as the material continues to melt therein. This trapping of gases can ultimately lead to sudden and unwanted discharge of the pent up gas.

To overcome the problems associated with an intermittent melting method, induction furnaces have been designed that allow for melting metal in a somewhat continuous melting process. However, these induction furnaces are limited in their use, as these existing designs are only able to accommodate melting of a primarily metal material. That is, these induction furnaces are not suitable for use in reclamation processes where the material to be melted is primarily non-conductive, such as slag, rock, or low grade ore, because the non-conductivity of these materials causes unique problems.

That is, problems arise when melting a substantially non-conductive material such as rocks in a standard induction furnace having a conductive crucible to heat and melt the material. In existing furnace designs, the crucible will be inductively heated and conduct heat to the material in direct contact with the crucible surface. Thus, an annular ring of molten material will rapidly form at the inner crucible surface. Unless the crucible is operated at a temperature much higher than the liquification temperature of the non-conductive material, the melting process will “stall” because of the poor thermal conductivity of the annular ring of molten material and the inability of heat to rapidly transfer inwardly toward the unmelted material.

If an induction furnace is operated to heat the crucible to a high temperature to improve melting of the substantially non-conductive material, the life of the crucible will be significantly shortened. The life of the conductive crucible can be further shortened by the erosion of the crucible caused by reactions that occur between the crucible and the molten material therein. Typically, the conductive crucible will contain carbon therein, and as such, will react with certain metallic oxides (e.g., iron) in the charge, producing liquid metal, carbon monoxide, and carbon dioxide. The liquid metal produced can further shorten the life of the crucible by pooling at the bottom thereof, which superheats in the bottom of the crucible.

Beyond the problems associated with efficiently heating the non-conductive material and maintaining crucible life, the implementation a continuous process for the melting of these substantially non-conductive materials is also problematic. Induction furnaces used for reclamation of small amounts of metal in a substantially non-conductive material require a construction that allows for separation and settling of the materials therein as well as a system/mechanism for removing an undesired material from the desired molten metal. Current induction furnaces that allow for a continuous melting of a metal lack such a capacity and construction. As such, induction furnaces for use in the reclamation of metal from substantially non-conductive materials such as rock or low-grade ore that allow for a continuous heating and melting operation are still not available.

Therefore, an induction furnace system designed to promote a continuous heating and melting operation of substantially non-conductive materials is desirable. Additionally, an induction furnace system that improves crucible life while efficiently melting the substantially non-conductive materials is also desired.

### BRIEF DESCRIPTION OF THE INVENTION

The present invention provides an induction furnace system constructed to heat and melt a solid material in a continuous melting operation. A stacked induction furnace includes a first furnace capable of continuously heating and melting a solid material and a second furnace in operable association with the first furnace to continuously receive molten material from the first furnace and maintain the material in a molten state until it is transferred as desired.

According to one aspect of the present invention, a stacked furnace system includes a first furnace having an induction coil to heat and melt a substantially non-conductive material contained in an upper crucible. The upper crucible has an opening in a bottom surface thereof to drain molten material therefrom. The stacked furnace system also includes a second furnace positioned below the first furnace having a lower crucible to receive the molten material drained from the opening, the second furnace constructed to maintain the molten material in a molten state in the lower crucible, and one or more power sources to power the first furnace and the second furnace.

In accordance with another aspect of the present invention, a stacked induction furnace includes a melting chamber to heat a melt therein that is composed of a substantially non-conductive material, a settling chamber positioned below the melting chamber to maintain the melt, and at least one induction coil at least partially surrounding the melting chamber and the settling chamber to generate a magnetic flux to heat the melt. The melting chamber includes an opening in a lower portion thereof to transfer the melt from the melting chamber to the settling chamber.

In accordance with yet another aspect of the present invention, a continuous process for heating and melting a material in an induction furnace system includes the steps of depositing a substantially non-conductive material into a melting crucible of a top induction furnace and inductively heating and melting the substantially non-conductive material in the melting crucible by way of a first induction coil positioned at least partially about the melting crucible. The process also includes the steps of transferring the melted material to a holding crucible of a bottom furnace by way of a passage formed in a bottom surface of the melting crucible and removing the melted material from the holding crucible at a controlled flow rate.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a front plan view of an induction furnace system according to one embodiment of the present invention.

FIG. 2 is a cross-sectional front view of a portion of the induction furnace system of FIG. 1.

FIG. 3 is a cross-sectional front view of a portion of the induction furnace system according to another embodiment of the present invention.

FIG. 4 is a detailed view of a susceptor according to an embodiment of the present invention that is useable in either of the aforementioned furnace systems.

FIG. 5 is a top plan view of a melting crucible and susceptors according to an embodiment of the present invention that is useable in either of the aforementioned furnace systems.

### DETAILED DESCRIPTION OF THE INVENTION

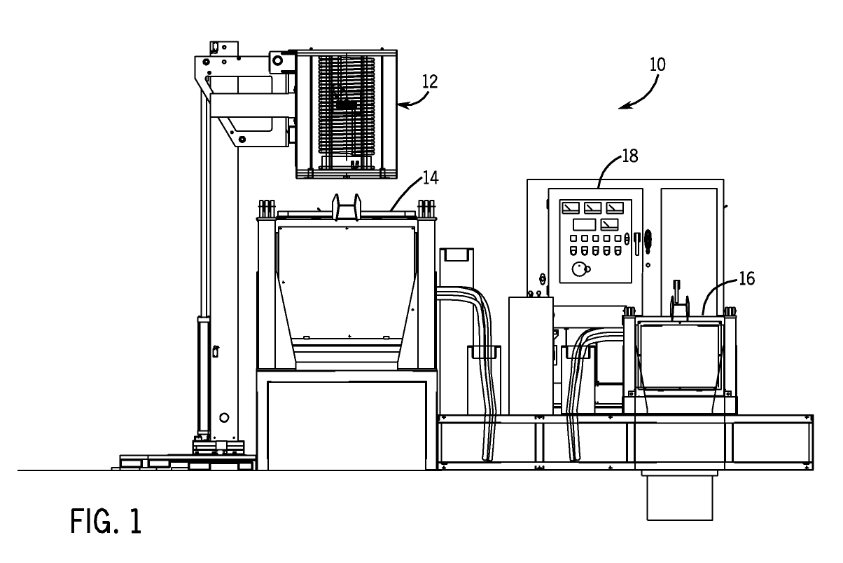

Referring to FIG. 1, one embodiment of an induction furnace system 10 according to the present invention is shown having a first upper furnace 12 and a second lower furnace 14 aligned in a stacked configuration. The upper furnace 12 is configured to receive a material therein that is heated and melted through inductive heating, as will be explained in greater detail below. The lower furnace 14 is positioned below upper furnace 12 to receive the melted material from the upper furnace 12. Lower furnace 14 is configured to maintain the temperature of the melted material or further heat the material, as determined by the specific operation being performed. Additional treatment of the melted material can also be performed in lower furnace 14 to improve the quality and purity of the melted material.

Induction furnace system 10 can also include an optional third development furnace 16. Development furnace 16 allows an operator to perform small trial experiments and melting operations on a chosen material to determine temperature and time for heating, as well as composition and chemistry of the material. Such information is useful in then performing a full-scale heating and melting operation of that material in the upper and lower furnaces 12, 14 of the induction furnace system 10. That is, trials performed in development furnace 16 provide information on a time required to melt the material, temperature needed, how long to let the melted material settle, and a suitable rate at which to transfer the melted material from the upper furnace 12 to the lower furnace 14.

Also shown in FIG. 1, a control panel 18 is provided and is constructed to control operational parameters and components in the induction furnace system 10. Control panel 18 is used by an operator to adjust voltage and/or current to the upper 12 and lower 14 furnaces as well as control the position and functioning of various components in the furnaces 12, 14 as will be explained in greater detail below.

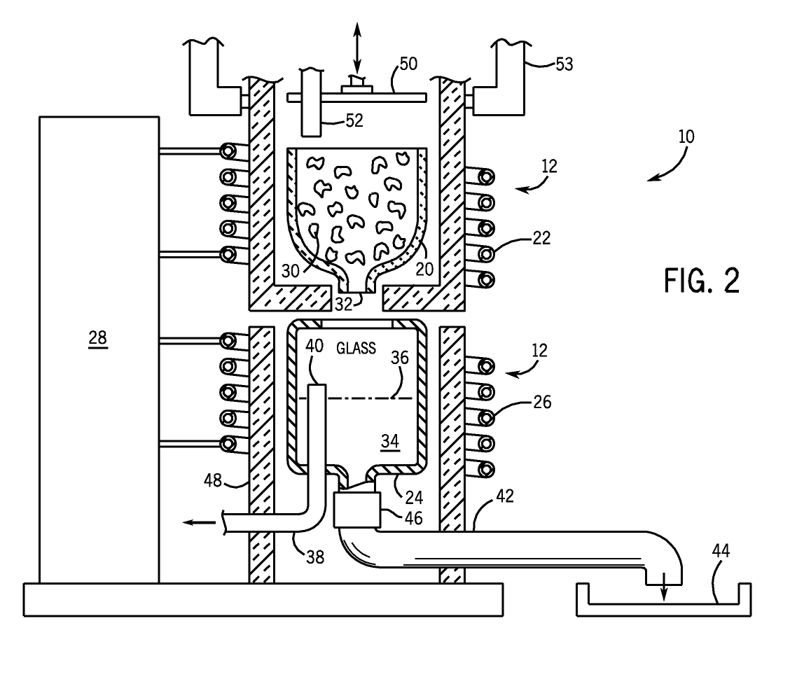

Referring now to FIG. 2, one embodiment of the upper furnace 12 and lower furnace 14 of induction furnace system 10 is shown in detail that allows for a continuous melting operation. Upper furnace 12 includes a melting crucible 20 (i.e., melting chamber) and a first set of induction coils 22 at least partially surrounding the melting crucible 20. The melting crucible 20 is formed of a refractory, electrically conductive material, such as a graphite or silicon carbide, although other suitable conductive materials can also be used.

Lower furnace 14 includes a settling crucible 24 (i.e., settling chamber) and a second set of induction coils 26 at least partially surrounding the settling crucible 24. Preferably, the settling crucible 24 is also composed of a suitable conductive material. It is also envisioned that lower furnace 14 comprise an electric furnace or other suitable high temperature furnace rather than an induction furnace and that the electric furnace could be separately powered from the upper furnace 12.

The first and second induction coils 22, 26 at least partially surround the exterior of the melting crucible 20 and the settling crucible 24 respectively. The induction coils 22, 26 are connected to one or more suitable high frequency power supplies 28 so that the magnetic field generated from AC current flowing through the coils 22, 26 inductively heats the melting crucible 20 and the settling crucible 24 respectively. It is envisioned that the first induction coils 22 and the second induction coils 26 are separately powered and that the amount of AC current flowing through the coils can be individually controlled to reflect heating requirements in the upper and lower furnaces 12, 14. Depending on the material being melted, a power supply frequency will range from an AC power frequency of 50-60 Hz up to 10 kHz. The induction coils 22, 26 may be air-cooled or water-cooled and may be comprised of solid or stranded conductors configured in what is commonly known as a Litz wire configuration. In the embodiment of FIG. 2, most if not all induced inductive heating in the upper furnace 12 occurs in the conductive melting crucible 20 when the material being melted is substantially non-conductive, as will be explained further hereinafter.

To begin a melting operation, melt 30 (i.e., the material to be heated and melted) is placed within melting crucible 20 and is heated to a desired temperature. The melt 30 can be a substantially non-conductive material such as rock, slag, or low grade ore. While generally composed of a substantially non-conductive material, the melt 30 also includes an amount of conductive metal therein, such as metallic iron or a semi-precious metal such as silver, copper, platinum, manganese, or another similar metal that is to be reclaimed therefrom. In order to reclaim the metal contained in melt 30, the melt 30 is heated to a molten state in upper furnace 12 to separate the waste material from the metal. That is, as the slag/rocks are heated to a melting state, conductive metal contained therein is melted to a liquid/viscous form. The melted conductive metal is drawn to the bottom of the melting crucible 20, as it is denser then the melted material from which it is separated.

Still referring to FIG. 2, melting crucible 20 also includes an opening or passage 32 positioned at the bottom thereof Passage 32 is sized to allow for transfer of the melt 30 from upper furnace 12 to lower furnace 14 in a metered amount depending on the constituents therein. Passage 32 also functions to speed up a heating and melting of melt 30 and extend the life of the melting crucible 20 by allowing melt 30 that is in a liquid form to drain out from crucible 20 and allow for melt 30 still in solid form to come into contact with the walls of melting crucible 20. That is, immediately upon liquefaction at the hot surface of the inductively heated melting crucible, the molten melt 30 is allowed to drain away by way of passage 32 and solid melt 30 comes into contact with melting crucible 20 thereby improving heat transfer thereto. By allowing melt 30 to drain out of melting crucible via passage 32, liquid metal is prevented from pooling at the bottom of melting crucible 20 and superheating, which could shorten life of the crucible 20. As melt 30 is transferred from upper furnace 12 to lower furnace 14, additional melt 30 is conveyed to melting crucible 20 through transfer tube 33 in order to maintain a sufficient amount of material therein. Thus, a continuous process of adding melt 30 to melting crucible 20 and of removing melt 30 from the melting crucible 20 is achieved. Passage 32 is further configured to be open and closed as needed during a heating and melting operation.

As part of the melting operation, it is also envisioned a filtering operation can be performed on the melt 30 that is in a molten state and drains down to the bottom of melting crucible 20. That is, a blast of high frequency AC current can be applied from upper furnace 12 to first induction coils 22 and be directed to the bottom of melting crucible 20 to separate a precious metal from the molten melt 30. In this manner, small particles of a waste material could be separated from melt 30 (and the molten precious metal) before it drains out of melting crucible 20.

As stated above, melt 30 from melting crucible 20 is drained or transferred into settling crucible 24 in lower furnace 14 by way of passage 32. Melt 30 is held in settling crucible 24, which maintains temperature of the melt 30 by way of second induction coils 26 positioned at least partially around the settling crucible 24. The melt 30 delivered to settling crucible 24 may, in some cases, be slightly conductive in the molten state, having an amount of conductive material 34 (i.e., molten metal) therein, as shown in FIG. 2. Melt 30 may also be substantially free of molten metal therein, and thus be substantially non-conductive. When melt 30 contains conductive material 34 therein, lower furnace 14 can be configured as a direct induction furnace wherein settling crucible is electrically non-conductive and second induction coils 26 are operated at a high enough frequency (e.g., up to 1 MHz) to directly inductively heat conductive material 34 and maintain the material in a molten state. When the settling crucible 24 is comprised of a conductive material, it also is inductively heated, in which case lower frequencies would be used to maintain heating of conductive material 34. In such a configuration, the AC power required by second induction coils 26 would thus be lower than that required by first induction coils 22, as the lower furnace 14 is designed to primarily maintain the temperature of the melt 30 at a specified level that is dependent upon the specific material being melted.

The holding of melt 30, and the maintaining of a desired temperature thereof, allows for certain chemical and physical processes to be completed in the melt 30 that enables the desired removal of molten metal 34 therefrom. As melt 30 is held in the settling crucible 24, it further settles and separates into somewhat distinct regions composed of differing materials. That is, once melt 30 is melted and allowed to settle in settling crucible 24, it separates into two constituents having different densities. As shown in the embodiment of FIG. 2, the molten metal 34 included in melt 30 settles to the bottom of settling crucible 24. On top of the metal is a layer of “glass” 36 that is formed by the melted by-product included in the melt 30. The molten metal 34 included in melt 30 has a greater density than the glass 36. As an example, precious metals are typically found to be 1.75 times as heavy as the by-product or glass 36 from which they are separated. In addition to the difference in density, impurities are drawn to the top of the melt 30 by glass 36 on top of the pure molten metal 34, thus further refining and separating the molten metal 34 from the glass/by-product 36 and any impurities. To drain off and remove this glass 36 from the settling crucible 24, a stand pipe 38 is included in the settling crucible 24 and is constructed to remove glass 36 from the melt 30 when the melt 30 reaches a certain height in settling crucible 24. That is, a top layer of glass 36 rises to the level of an opening 40 in stand pipe 38 and drains into stand pipe 38. In this manner, glass 36 is continuously removed from melt 30 and a maximum amount of melt 30 that can be held in settling crucible 24 is maintained.

As shown in FIG. 2, settling crucible 24 is connected to passage 42 formed into a bottom surface of settling crucible 24. Connecting passage 42 transfers molten metal 34 that has settled to the bottom of melt 30 out of settling crucible 24 to, in one embodiment, a mold 44 or other device in which the molten metal 34 is to be used. The flow of molten metal 34 out of settling crucible 24 through connecting passage 42 can be metered or controlled by a gate 46 (i.e., interstop) positioned in connecting passage 42. The gate 46 is opened and closed at specified times to ensure that the melt 30 has settled properly in the settling crucible 24 and to ensure that a sufficient amount of melt 30 is contained in the settling crucible 24. The controlled flow of molten metal 34 through connecting passage 42 also allows for proper placement and switching of molds 44 to receive the molten metal 34 when required. Gate 46 can be automatically controlled by control panel 18 (shown in FIG. 1) according to a desired flow for a given molten material.

While use of connecting passage 42 and gate 46 has been described for removing molten metal 34 from settling crucible 24, it is also envisioned that molten metal 34 could be removed by other alternative methods and mechanisms. That is, induction furnace system 10 could be configured to allow for upper furnace 12 to swing out and away from lower furnace 14. Settling crucible 24 in lower furnace 14 could then be tipped and dumped to remove molten metal 34 therefrom in a manner known in the art.

In the melting operation, as melt 30 is transferred out from melting crucible 20 and settling crucible 24, melt 30 is also being added back into melting crucible 20 at a substantially similar rate to keep a desired quantity of melt therein. As the filling and draining of melting crucible 20 occurs on a continuous basis, no “bridging” of the melt 30 therein is allowed to occur. That is, no solidification of a top layer on melt 30 is allowed to occur as material is continuously being added. As such, gases do not accumulate in the melting crucible 20 and unwanted discharge of any pent-up gas is prevented.

Referring again to FIG. 2, also included in induction furnace system 10 is a layer of insulation 48 to thermally shield the melting crucible 20 and settling crucible 24 from surrounding components in the induction furnace system 10. Insulation 48 is comprised, for example, of an air-bubbled ceramic composition or other suitable material known in the art. Beyond thermally insulating the melting crucible 20 and settling crucible 24 from surrounding components in the induction furnace system 10, insulation 48 also helps to retain heat within the crucibles 20, 24 and thus lower the amount of energy required to maintain a desired temperature in the crucibles 20, 24. Insulation 48 can also serve as an electrical insulator between the crucibles 20, 24 and the induction coils 22, 26.

A cover 50 can also be placed on melting crucible 20. The cover 50 joins with melting crucible 20 to retain heat and also to allow the control of the gaseous by-products inside the upper furnace 12 during operation. In processes which generate such gaseous by-products, the cover 50 may be provided with one or more outlets 52 to enable the gaseous by-products to either escape from the furnace 12 in a controlled manner or be recycled for other purposes. Cover 50 can also be configured to be raised manually or automatically from and lowered to melting crucible 20 as needed.

It is also envisioned that a rotatable support 53 can be attached to upper furnace 12. Rotatable support 53 allows for tipping of the melting crucible 20 to pour out the melt 30 therein. While passage 32 also serves to empty melt 30 from melting crucible 20, addition of rotatable support 53 can be used for cleaning or mass removal of melt 30 from melting crucible 20 in case of power failure or other malfunction.

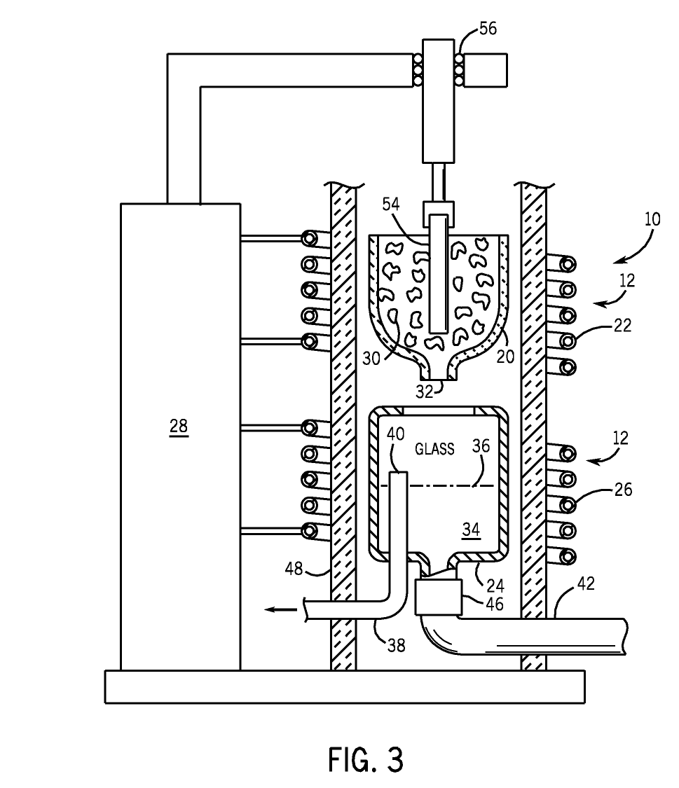

Referring now to FIG. 3, another embodiment of induction furnace system 10 is shown. In this embodiment, melting crucible 20 is composed of a non-conductive material that is resistive to inductive heating from first induction coil 22. A separate mechanism is thus provided to be the primary source of heat in the heating and melting of the substantially non-conductive melt 30. As shown in FIG. 3, a susceptor 54 is positioned within the volume of the melting crucible 20 and into the melt 30. The susceptor 54 is composed of a conductive material that is inductively heated by first induction coil 22. The first induction coil 22 is energized and the magnetic flux generated by the coil 22 induces a current in the susceptor 54 that, in turn, heats up susceptor 54. As the current heats up the susceptor 54, which is located in melt 30, the temperature of the melt 30 is raised by radiant and convective heating.

Preferably, the susceptor 54 is comprised of a refractory material such as graphite, although it is also envisioned that other materials can be used that can be heated to the temperature of the melt without losing mechanical integrity. When composed of graphite, the temperature of the susceptor 54 can be taken up to the temperature limit of graphite (about 2600° C.), allowing heat to be driven to the melt 30 and resulting in faster processing times and higher yield. The temperature of susceptor 54 can be controlled via the current being run through first induction coil 22, thus controlling the temperature of the melt 30 as well.

As shown in FIG. 3, the susceptor 54 is preferably in the shape of a cylinder or rod. Placement of the susceptor 54 affects the performance of the upper furnace 12 and the product obtained therefrom. The susceptor 54 is ideally positioned such that the heat transfer conditions in the direction of heat flow from the susceptor 54 should be similar for all parts of the melt 30. As such, ideally the susceptor 54 is positioned in the center of the melting crucible 20. Such a placement and configuration assist in promoting an even heat distribution in the melt 30 for a more efficient melting process. Such a configuration allows the use of a taller, and therefore larger crucible 20. For example, crucible 20 can have a diameter to height ratio of 1:2.

In addition to providing heat to the melt 30, the graphite susceptor 54 also prevents oxidation in the molten metal 34 contained in the melt 30 by stripping oxygen therefrom. That is, oxygen present in the melt 30 bonds with the graphite to form CO, which is then exhausted from the upper furnace 12. Over time, the conductive susceptor 54 degrades due to oxidation, and other possible chemical reactions, between the susceptor 54 and melt 30. Susceptor 54 is preferably cylindrical or rod shaped. Such a configuration degrades more evenly, therefore extending the life of the susceptor 54 beyond a susceptor of alternate configurations.

A graphite susceptor rod 54 of the type explained herein is generally not used in the prior art since most systems use conductive crucibles and because susceptor 54 occupies space in the melting crucible 20. Furthermore, it is generally believed that a close proximity of the conductive member to the induction coils is most efficient. However, since the induction heating system described herein is preferably used to separate metals, it is preferred to use a non-conductive crucible for even heat distribution. Also, the single graphite susceptor rod 54 of the described embodiment is sized so that a majority of the melting crucible 20 is available for a melt 30 to be placed therein. As shown in FIG. 3, susceptor 54 is also attached to a mechanism 56 that can raise and lower the susceptor 54 into and out of the melting crucible 20 as is desired during a heating and melting operation.

As described above with respect to the embodiment of induction furnace system 10 set forth in FIG. 3, a substantially non-conductive melt 30 is contained in a non-conductive melting crucible 20 of upper furnace 12. While an induction furnace system 10 constructed as such may seem inefficient for heating the non-conductive melt 30 as compared to a system having a conductive crucible, it improves longevity of the crucible 20 and helps to promote even heat distribution in the melt 30. While susceptor 54 has been described as being included in an induction furnace system 10 having a non-conductive melting crucible 20 to improve crucible life, it is also envisioned that susceptor 54 could also be included in an induction furnace system 10 having a conductive melting crucible 20.

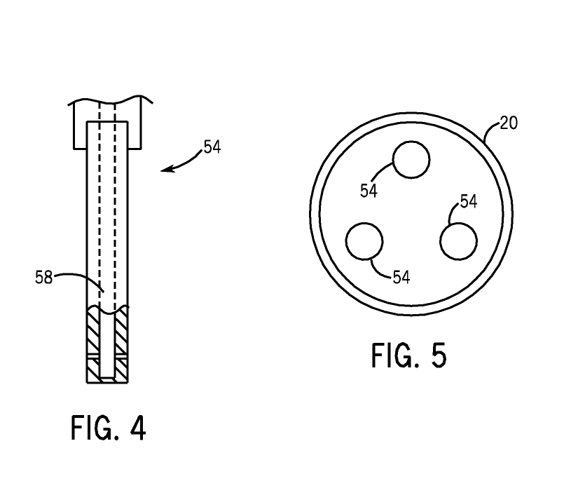

Referring now to FIGS. 4 and 5, additional embodiments of susceptor 54 are shown. As illustrated in FIG. 4, susceptor 54 is configured as a cylinder or rod having a hollow cavity 58 running therethrough. As shown in FIG. 5, it is also envisioned that multiple susceptor rods 54 be positioned in melting crucible 20. The susceptor rods 54 are positioned equidistant from one another and from the center of the melting crucible 20. While these additional embodiments of susceptor 54 have been shown, it is also envisioned that the susceptor 54 may take other forms not described herein that: maximize surface area contact between the susceptor 54 and the melt; distribute heat evenly within the melt to maximize efficiency in the melting process; and allow for even degradation of the susceptor 54. For example, it is also envisioned that susceptor 54 be in an inverted bowl-shape that is sized to allow for a quantity of melt to be present inside a volume thereof.

Therefore, according to one embodiment of the present invention, a stacked furnace system includes a first furnace having an induction coil to heat and melt a substantially non-conductive material contained in an upper crucible. The upper crucible has an opening in a bottom surface thereof to drain molten material therefrom. The stacked furnace system also includes a second furnace positioned below the first furnace having a lower crucible to receive the molten material drained from the opening, the second furnace constructed to maintain the molten material in a molten state in the lower crucible, and one or more power sources to power the first furnace and the second furnace.

In accordance with another embodiment of the present invention, a stacked induction furnace includes a melting chamber to heat a melt therein that is composed of a substantially non-conductive material, a settling chamber positioned below the melting chamber to maintain the melt, and at least one induction coil at least partially surrounding the melting chamber and the settling chamber to generate a magnetic flux to heat the melt. The melting chamber includes an opening in a lower portion thereof to transfer the melt from the melting chamber to the settling chamber.

In accordance with yet another embodiment of the present invention, a continuous process for heating and melting a material in an induction furnace system includes the steps of depositing a substantially non-conductive material into a melting crucible of a top induction furnace and inductively heating and melting the substantially non-conductive material in the melting crucible by way of a first induction coil positioned at least partially about the melting crucible. The process also includes the steps of transferring the melted material to a holding crucible of a bottom furnace by way of a passage formed in a bottom surface of the melting crucible and removing the melted material from the holding crucible at a controlled flow rate.

The present invention has been described in terms of the preferred embodiments, and it is recognized that equivalents, alternatives, and modifications, aside from those expressly stated, are possible and within the scope of the appending claims.

What is claimed is:

1. A stacked furnace system comprising:
a first furnace having an induction coil to heat and melt a substantially non-conductive material contained in an upper crucible, the upper crucible having an opening in a bottom surface thereof to drain molten material therefrom;
a second furnace positioned below the first furnace, the second furnace having a lower crucible to receive the molten material drained from the opening, the second furnace constructed to maintain the molten material in a molten state in the lower crucible; and
one or more power sources to power the first furnace and the second furnace.

2. The stacked furnace system of claim 1 wherein the upper crucible is composed of a conductive material that is inductively heated by the induction coil.

3. The stacked furnace system of claim 1 wherein the upper crucible is comprised of a non-conductive material.

4. The stacked furnace system of claim 3 wherein the first furnace system further comprises at least one conductive susceptor located within a perimeter of the upper crucible and in thermal contact with the substantially non-conductive material.

5. The stacked furnace system of claim 4 wherein the at least one conductive susceptor is configured as a graphite rod.

6. The stacked furnace system of claim 1 wherein the second furnace further comprises a transfer pipe connected to the lower crucible to remove a molten metal contained in the molten material from the lower crucible.

7. The stacked furnace system of claim 6 wherein the transfer pipe further includes a gate therein to regulate removal of the molten metal from the lower crucible

8. The stacked furnace system of claim 6 wherein the transfer pipe empties to a mold to receive the molten metal therein.

9. The stacked furnace system of claim 1 further comprising a stand pipe positioned in the settling crucible to draw off a top surface layer of the molten material.

10. The stacked furnace system of claim 1 further comprising a third furnace, wherein the third furnace is configured to inductively heat the substantially non-conductive material to determine operational settings in the induction furnace system.

11. The stacked furnace system of claim 1 further comprising a rotatable support connected to the upper crucible to rotate the upper crucible to a titled position to pour out the molten material.

12. The stacked furnace system of claim 1 wherein the first furnace further comprises a cover attached to the upper crucible to retain heat therein.

13. The stacked furnace system of claim 1 wherein the second furnace further comprises an induction coil and wherein the lower crucible is composed of a conductive material that is inductively heated by the induction coil.

14. A stacked induction furnace comprising:
a melting chamber to heat a melt therein, the melt composed of a substantially non-conductive material;
a settling chamber positioned below the melting chamber to maintain the melt;
at least one induction coil at least partially surrounding the melting chamber and the settling chamber to generate a magnetic flux to heat the melt; and
wherein the melting chamber includes an opening in a lower portion thereof to transfer the melt from the melting chamber to the settling chamber.

15. The stacked induction furnace of claim 14 wherein the melting chamber is composed of a non-conductive material resistive to heating induced by the magnetic flux.

16. The stacked induction furnace of claim 14 further comprising a conductive center core positioned within a volume of the melting chamber and heated by the magnetic flux to heat the melt.

17. The stacked induction furnace of claim 16 wherein the conductive center core is a graphite cylinder.

18. The stacked induction furnace of claim 14 further comprising a discharge passage connected to the settling chamber to remove the melt therefrom.

19. The stacked induction furnace of claim 18 wherein the discharge passage further comprises an interstop positioned therein to control a flow of the melt.

20. The stacked induction furnace of claim 14 further comprising a stand pipe positioned in the settling chamber to remove a glass from the melt.

21. A continuous process for heating and melting a material in an induction furnace system comprising the steps of:
depositing a substantially non-conductive material into a melting crucible of a top induction furnace;
inductively heating and melting the substantially non-conductive material in the melting crucible by way of a first induction coil positioned at least partially about the melting crucible;
transferring the melted material to a holding crucible of a bottom furnace by way of a passage formed in a bottom surface of the melting crucible; and
removing the melted material from the holding crucible at a controlled flow rate.

22. The process of claim 21 further comprising depositing an additional amount of the substantially non-conductive material into the melting crucible at a rate equal to a rate at which the melted material is transferred out of the melting crucible through the passage.

23. The process of claim 21 further comprising maintaining a temperature of the melted material in the holding crucible by way of a second induction coil positioned at least partially about the holding crucible.

24. The process of claim 23 wherein the step of maintaining a temperature of the melted material in the holding crucible is at a lower temperature than a temperature of the melting crucible

25. The process of claim 21 further comprising positioning a graphite susceptor rod within the melting crucible to heat the substantially non-conductive material.

26. The process of claim 21 further comprising removing a by-product from the melted material in the holding crucible by positioning a stand pipe in the holding crucible.

27. The process of claim 21 further comprising removing a by-product from the melted material in the melting crucible by positioning a cover thereover, the cover having an exhaust pipe connected thereto.
